(19) United States
(12) Patent Application Publication
(10) Pub. No.: US 2011/0041515 A1
(43) Pub. Date: Feb. 24, 2011

(54) High Efficiency, Corrosion Resistant Heat Exchanger and Method of Use Thereof

(76) Inventor: Michael Lee Fraim, Oxnard, CA (US)

Correspondence Address: Ballard Spahr LLP, SUITE 1000, 999 PEACHTREE STREET, ATLANTA, GA, 30309-3915, US

(21) Appl. No.: 12/738,792

(22) PCT Filed: Oct. 16, 2008
(86) PCT No.: PCT/US08/11786

§ 371 Date: Oct. 19, 2010

Related U.S. Application Data
(60) Provisional application No. 60/999,467, filed on Oct. 18, 2007.

(51) Int. Cl. C02F 1/12; F28F 19/00; F25B 1/00; F28F 3/08; F25B 21/02

(52) U.S. Cl. 62/3.2; 165/134.1; 165/104.27; 165/166; 203/11

(57) ABSTRACT

Disclosed are anodically protected, corrosion resistant, self cleaning, high efficiency, submerged tube and plate heat exchangers. Also disclosed are systems for purifying liquids using the anodically protected, corrosion resistant, self cleaning, high efficiency, submerged tube and plate heat exchangers. Further disclosed are methods for purifying liquids using the anodically protected, corrosion resistant, self cleaning, high efficiency, submerged tube and plate heat exchangers.

### CROSS-REFERENCE TO RELATED APPLICATIONS

This application claims benefit of priority to U.S. Provisional Application Ser. No. 60/999,467 filed Oct. 18, 2007, which is herein incorporated by reference in its entirety.

### FIELD OF THE INVENTION

The present disclosure relates to anodically protected high efficiency, corrosion resistant, self cleaning submerged tube and plate heat exchangers. The present disclosure further relates to systems comprise the disclosed heat exchangers and, methods for the use thereof.

### BACKGROUND OF THE INVENTION

The use of heat exchangers is ubiquitous. Some embodiments, such as automobile radiators, are constructed to transfer heat away from a source of energy without regard to conservation of energy. Industrial processes, however, consume large amounts of energy. In some instances, the cost of energy used in producing a commodity can exceed the price at which the commodity can be sold. For example, desalinization of water requires a large expenditure of energy. This process, which entails removal of water from the salts and impurities of raw sea water, typically employs distillation. For pure water, the energy needed to simply raise the temperature of water one degree Celsius is approximately 4.18 kJ/kg. However, to vaporize that same quantity of water requires approximately 2260 kJ/kg. Therefore, it has long been recognized that an enormous amount of energy is consumed by the latent heat of vaporization. Capture and utilization of this immense energy sink has led to the development and use of heat exchangers.

Heat exchangers rely on the efficient transfer of energy in the form of heat from one point in a process where excess heat needs to be dissipated to another point wherein energy input is required. Some materials transfer heat more efficiently and more effectively than others. The use of these materials has gained wide use and acceptance for the manufacture of heat exchangers designed for specific industrial processes. In continuous processes, such as desalinization, the energy consumed by the latent heat of vaporization of water is captured from the condensing purified water and transferred to incoming, unpurified water. However, some processes, such as distillation of ethanol from a biomass, may utilize raw water as the coolant and the energy transfer is only used to cool the ethanol. Others have used raw water as the coolant in processes involving the manufacture of highly corrosive materials such as sulfuric acid. The heat exchangers designed for each of these processes necessarily comprise different material for their heat exchanger tubes or plates.

Processes utilizing heat exchangers must deal with the build-up of unwanted scale or other impurities on the surface of the heat exchanger tubes or plates. Succinctly stated, dirty or fouled fluid enters the heat exchanger and purified fluid exits, however, the unwanted material contained in the fluid as it enters must be kept from fouling the tubes or plates of a heat exchanger. Fouling of the tube or plate surface reduces the efficiency and effectiveness of heat transfer from the purified fluid to the incoming fluid or the coolant. This lowered efficiency and effectiveness increases energy costs. It also requires that the system be shut down periodically so that the heat exchanger tubes or plates can be cleaned. Halting a process for cleaning significantly increases the cost of production. There is therefore a need for a heat exchanger that reduces fouling of the heat exchange surface and that is adaptable to any type of process.

### SUMMARY OF THE INVENTION

The disclosed heat exchangers comprise surfaces that eliminate or greatly reduce the amount of surface fouling that develops during continuous use. The heat exchangers use a combination of elements to provide anti-fouling. The tubes or plates of the heat exchangers are provided with a pulsed anodic current. This pulsed current when used in combination with the dimensionally stable, substantially non-metallic, electrically and thermally conductive materials disclosed herein, provide highly efficient and non-corrosive heat exchanger surfaces.

The disclosure further relates to processes comprising a high efficiency, non-corrosive heat exchanger in combination with a thermoelectric cooler and plate heat exchanger. The combination of these elements provide high energy efficient processes for, inter alia, desalinization, distillation of a volatile liquid from an impure liquid, slurry, or biomass, purification of oil field wastes, and the like.

The disclosure also relates to method for using a high efficiency, non-corrosive heat exchanger in combination with other units, inter alia, pumps, vapor compression units, secondary heat exchangers, electro-chemical precipitation cells, de-gassing units and the like.

The disclosure yet further relates to methods for providing corrosion resistance to both submerged tube and plate heat exchangers.

The disclosure yet still further relates to corrosion resistant surface that can be modified to protect against highly acidic or caustic, highly salt containing, or against fluid having biological materials dispersed therein that have a high rate of surface sedimentation.

### BRIEF DESCRIPTION OF THE FIGURES

FIG. 1 depicts a submerged tube heat exchanger comprising submerged tubes having an anodically protected, dimensionally stable, substantially non-metallic, electrically and thermally conductive outer surface.

FIG. 2A depicts a detailed view of the tube depicted in FIG. 1 depicting one embodiment for electrical communication of the dimensionally stable, substantially non-metallic, electrically and thermally conductive outer surface with a positive terminal of a pulse voltage source.

FIG. 2B depicts a cut away view of the surface depicted in FIG. 2A.

FIG. 3 depicts a further embodiment for electrical communication of the dimensionally stable, substantially non-metallic, electrically and thermally conductive outer surface with a positive terminal of a pulse voltage source.

FIG. 4 depicts yet a further embodiment for electrical communication of the dimensionally stable, substantially non-metallic, electrically and thermally conductive outer surface with a positive terminal of a pulse voltage source wherein the means for electrical communication further provides mechanical support for the tubes.

FIG. 5 depicts a heat exchanger equipped with a plurality of sources of ultrasonic energy that are also cathode surfaces.

FIG. 6 depicts a top cut away view of the heat exchanger depicted in FIG. 5.

FIG. 7 depicts a disclosed submerged tube heat exchanger that provides a falling film along the outside of the tubes.

FIG. 8 depicts a close up view of the means for providing a falling film in the exchanger depicted in FIG. 7.

FIG. 9 depicts the submerged tube heat exchange of FIG. 7 with an electro-chemical precipitation cell.

FIG. 10 depicts a heat exchanger adapted for use with a vapor compression unit and adapted to cause a falling film to form along the inside of the tubes.

FIG. 11 depicts a plate heat exchanger embodiment.

FIG. 12 depicts a plate heat exchanger embodiment coupled with an electro-chemical precipitation cell.

FIG. 13 depicts a high efficiency system for purifying a liquid.

FIG. 14 depicts a high efficiency system for purifying a liquid that utilizes a water soluble or water miscible organic solvent as a means of precipitating an inorganic impurity.

FIG. 15 depicts an arrangement of tubes in a submerged tube heat exchanger.

FIG. 16 depicts the positive voltage current on each of the tubes depicted in the array of FIG. 15 when the tubes are pulsed sequentially over time.

### DETAILED DESCRIPTION

The present invention can be understood more readily by reference to the following detailed description, drawings, examples, and claims, and their previous and following description. However, before the present compositions, articles, devices, and methods are disclosed and described, it is to be understood that this invention is not limited to the specific compositions, articles, devices, and methods disclosed unless otherwise specified, as such can, of course, vary. It is also to be understood that the terminology used herein is for the purpose of describing particular embodiments only and is not intended to be limiting.

The following description of the invention is provided as an enabling teaching of the invention in its currently known embodiments. To this end, those skilled in the relevant art will recognize and appreciate that many changes can be made to the various embodiments of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

Disclosed are materials, compounds, compositions, and components that can be used for, can be used in conjunction with, can be used in preparation for, or are products of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. Thus, if a class of substituents A, B, and C are disclosed as well as a class of substituents D, E, and F and an example of a combination embodiment, A-D is disclosed, then each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all embodiments of this disclosure including, but not limited to any components of the compositions and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed. In this specification and in the claims which follow, reference will be made to a number of terms which shall be defined to have the following meanings:

As used herein, the singular forms “a,” “an” and “the” include plural referents unless the context clearly dictates otherwise. Thus, for example, reference to a “component” includes embodiments having two or more such components, unless the context clearly indicates otherwise.

“Optional” or “optionally” means that the subsequently described event or circumstance can or cannot occur, and that the description includes instances where the event or circumstance occurs and instances where it does not. For example, the phrase “optional component” means that the component can or can not be present and that the description includes both embodiments of the invention including and excluding the component.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

As used herein, a “wt. %” or “weight percent” or “percent by weight” of a component, unless specifically stated to the contrary, refers to the ratio of the weight of the component to the total weight of the composition in which the component is included, expressed as a percentage.

As used herein, “impure fluid” and “raw fluid” are used interchangeably and refer to impure feedstocks wherein a component of the feedstock is removed utilizing the disclosed heat exchangers and/or the disclosed systems and related methods. For example, sea water is an impure fluid and is referred to as the raw fluid wherein water is removed. In other examples, a raw fluid can be a waste treatment sludge wherein the volatiles are removed such that a relatively concentrated waste is provided that can be transported or otherwise disposed of. In other uses, a biomass, such as in ethanol production, can be treated by the disclosed heat exchangers, systems, and methods to remove the volatile ethanol.

As used herein, “process fluid” and “process vapor” refers to the volatile component removed by the disclosed systems and methods. For example, in a desalinization process, pure water can be the process fluid which at different stages of the process exists as a process vapor prior to condensing in the heat exchanger.

As used herein, “brine concentration factor” is defined as the concentration of dissolved salts, inter alia, NaCl, CaSO₄, and the like, in a raw fluid exiting a heat exchanger divided by the concentration of dissolved salts entering a heat exchanger. For example, a raw fluid having a total dissolved salt level of 7000 ppm entering the heat exchanger and having a total dissolved salt level of 14000 ppm leaving the heat exchanger will have a brine concentration factor of 2.0.

The heat exchangers disclosed herein can provide a more efficient system in several ways. By reducing the amount of fouling that takes place during use of the heat exchanger, the period of time between operational shut downs is significantly increased. By providing for a more efficient utilization of energy, the cost of manufacture is significantly reduced. By providing a heat exchanger that is compatible with all types of processes, the need for different types of heat exchangers is removed.

The present disclosure relates to an anodically protected, corrosion resistant, self cleaning, high efficiency heat exchanger and methods for high efficiency purification of liquids. One or more surfaces of the heat exchanger can comprise a dimensionally stable, substantially non-metallic, electrically and thermally conductive material or a dimensionally stable, substantially non-metallic, electrically and thermally conductive coating applied thereto.

### Dimensionally Stable Materials and Coatings

The tubes that comprise the submerged tube heat exchangers disclosed herein can comprise either a metal that has a high efficiency for conducting heat, or a composite material. In a first embodiment, the tubes comprise a metal, for example, titanium metal that is further coated with a dimensionally stable, substantially non-metallic, electrically and thermally conductive material. One type of coating relates to mixed metal oxide coatings. The mixed metal oxides suitable for use in coating titanium tubes are crystalline, electrically conductive coatings that can activate the titanium tubes and enable them to function as an anode according to the present disclosure while still offering protection to the titanium metal surface. The mixed metal oxides that can serve as electrically conductive protective coatings have an extremely low consumption rate, measured in terms of milligrams pre ampere-year and thereby serve not only to protect the titanium tube, but also to provide an electrically homogeneous surface.

Embedded within these coatings can be a conductive metal, for example, a metal or substantially metal wire that provides electrical communication between the heat exchanger tubes and the positive terminal of a pulsed current voltage source.

The disclosed heat exchanger plate can also comprise a dimensionally stable, substantially non-metallic, electrically and thermally conductive material or a coating comprising a dimensionally stable, substantially non-metallic, electrically and thermally conductive material. The coating which comprises the plate surface and which provides protection to the plate can also have a metal or substantially metal wire that provides electrical communication between the heat exchanger tubes and the positive terminal of a pulsed current voltage source.

In one embodiment the surface of the tubes or plates are coated with a hydrophobic, but electrically conductive, material.

The tubes can also comprise carbon fiber and/or a carbon particle mix in a high temperature epoxy resin.

In a first aspect, the tubes or plates of the disclosed heat exchangers comprise a carbon fiber or a carbon particle mix and a high temperature epoxy resin. For this aspect, from about 25% to about 27% by weight of carbon content provides a suitable material that provides the required thermal and electrical conductive path, for example, from the inner wall to the outer wall of a tube or plate that comprises carbon fiber, carbon particles, or a mixture thereof.

In one embodiment, the tubes or plates comprise:

i) at least about 27% by weight of carbon fiber, carbon particles, or a mixture thereof; and

ii) from 10% to 50% by weight of a glass fiber.

Glass fibers provide a lower cost method of inducing strength and rigidity into the carbon fiber, carbon particles, or carbon fiber/carbon particle admixture.

In a further embodiment, the tubes or plates comprise:

i) at least about 27% by weight of carbon fiber, carbon particles, or a mixture thereof; and

ii) from 0% to about 50% by weight, of glass fiber.

In another embodiment, the tubes or plates comprise:

i) at least about 23% by weight of carbon fiber, carbon particles, or a mixture thereof; and

ii) from 0% to about 10% by weight, of a metallic fiber.

The addition of metallic fiber to a tube, plate, or a coating for a tube or a plate provides for a more uniform electrical conductivity along the tube or plate axis.

In another further embodiment, the tubes or plates comprise:

i) at least about 27% by weight of carbon fiber, carbon particles, or a mixture thereof; and

ii) from 0% to about 20% by weight, of thermally conductive metallic flakes.

The addition of metallic fibers or flakes to a tube, plate, or a coating for a tube or a plate provides for a lower resin viscosity that increases both the electrical and thermal conductivity. The formulator can choose various iterations to the carbon fiber, carbon particle, and mixtures thereof coatings. For example, the formulator can choose carbon fibers to provide a relatively viscous coating having high surface area and greater electrical charge density. However, the formulator can modify, by using skills known in the art, the viscosity of the carbon fiber or carbon particle containing coating in a manner that provides a coating that has low viscosity and therefore can be applied more easily.

Likewise, the formulator can manipulate the lower viscosity resins which comprise metallic fiber or flakes to provide a more viscous, higher surface area coating. In some cases, multiple layers of coatings can be applied such that the current flow remains unimpeded and the tube or plate surface charge is homogeneous.

In still another embodiment for high temperature or high pressure heat exchanger applications, the tubes or plates comprise titanium metal, titanium sub-oxide, ceramic material or metal carbide substrates that are coated with a dimensionally stable coating, for example, boron doped diamond, Ti₄O₇ (monotitanium(I) dititanium(II), lead oxide, ruthenium oxide, or iridium oxide.

In still another embodiment, the tubes or plates comprise:

i) at least about 27% by weight of carbon fiber, carbon particles, or a mixture thereof; and

ii) from 0% to about 15% by weight, of a metal carbide.

Non-limiting examples of metal carbides include silicon carbide and boron carbide. One example of the disclosed heat exchangers comprises:

i) at least about 27% by weight of carbon fiber, carbon particles, or a mixture thereof; and

ii) from 0% to about 15% by weight, of silicon carbide.

Another example of this embodiment comprises:

i) at least about 27% by weight of carbon fiber, carbon particles, or a mixture thereof; and

ii) from 0% to about 15% by weight, of boron carbide.

In a yet further embodiment, the tubes or plates comprise:

i) at least about 27% by weight of carbon fiber, carbon particles, or a mixture thereof; and

ii) from 0% to about 15% by weight, of a metal oxide.

Non-limiting examples of metal oxides include aluminum oxide, lead oxide, iridium oxide, and titanium oxide. One example of the disclosed heat exchangers comprises:

i) at least about 27% by weight of carbon fiber, carbon particles, or a mixture thereof; and

ii) from 0% to about 15% by weight, of aluminum oxide.

Another example of this embodiment comprises:

i) at least about 27% by weight of carbon fiber, carbon particles, or a mixture thereof; and

ii) from 0% to about 15% by weight, of lead oxide.

A further example of this embodiment comprises:

i) at least about 27% by weight of carbon fiber, carbon particles, or a mixture thereof; and

ii) from 0% to about 15% by weight, of iridium oxide.

A still further example of this embodiment comprises:

i) at least about 27% by weight of carbon fiber, carbon particles, or a mixture thereof, and

ii) from 0% to about 15% by weight, of titanium oxide.

In another aspect, the tubes or plates of the disclosed heat exchangers comprise a titanium sub-oxide ceramic material.

For the submerged tube heat exchangers, a dimensionally stable conductive material can comprise the entire tube. In another aspect, a dimensionally stable conductive material of another composition can be applied to a tube comprising a second dimensionally stable conductive material. For example, the tube can comprise carbon fiber, carbon particles, or a mixture thereof and a dimensionally stable coating comprising a metal oxide or metal carbide as described herein above, can be applied thereto. A further aspect relates to tubes comprising carbon fiber, carbon particles, or a mixture thereof and a dimensionally stable anode coating chosen from a boron doped diamond coating, ceramic alloys of iridium oxide, or ceramic alloys of ruthenium oxide.

An example of a dimensionally stable anode coating includes ELTECH™ 300 and 600 coatings.

The mixed metal oxides suitable for use in coating titanium tubes are crystalline, electrically conductive coatings that can activate the titanium tubes and enable them to function as an anode according to the present disclosure. The mixed metal oxides that can serve as electrically conductive protective coatings have an extremely low consumption rate, measured in terms of milligrams pre ampere-year and thereby serve not only to protect the titanium tube, but also to provide an electrically homogeneous surface.

The aluminum flakes and powders that can be used in the dimensionally stable anode coating are available from AVL Metal Powders of Belgium. These materials comprise atomized aluminum powder that is granular or spherical in particle shape while the flakes or pastes that comprise aluminum, are produced by either mechanical stamping or ball milling and are therefore flattened platelets. Examples of these aluminum flakes and powders include #02 having the following particle size distribution: d₉₀ 180 (μm), d₅₀ 86 (μm), and d₁₀ 28 (μm). Another example includes #8880/NL having the following particle size distribution: d₉₀ 55 (μm), d₅₀ 21 (μm), and d₁₀ 6 (μm). As used herein d₉₀ is the size of particles wherein 90% of the particles have a size lower than that size. For example, a d₉₀ of 55 μm represents a particle size distribution wherein 90% of the particles are 55 μm or less. As used herein d₁₀ is the size of particles wherein 10% of the particles have a size lower than that size. For example, a d₁₀ of 6 μm represents a particle size distribution wherein 10% of the particles are 6 μm or less. As used herein d₅₀ is the size of particles wherein 50% of the particles have a size lower than that size and 50% of the particles have a size greater than that size. For example, a d₅₀ of 21 μm represents a particle size distribution wherein 50% of the particles are 21 μm or less and 50% of the particles are 21 μm or greater in size.

Graphite and carbon that can be used in the dimensionally stable anode coating includes those available from Asbury Graphite Mills, Inc. Non-limiting examples include the following flakes: 230U having a typical size of 20 μm, a surface area of 6.5 m²/g and a resistivity of about 0.068 Ohm-cm and 5601 having a typical size of 12-15 μm, a surface area of 7 m²/g and a resistivity of about 0.066 Ohm-cm. Fibers available from Asbury include PAN AGM™ 94 having a typical size of ⅛″ and 150 μm with an axial resistivity of 0.0014 Ohm-cm.

The conductive material can comprise a high temperature epoxy resin and at least one of the following:

i) at least about 27% by weight of carbon fiber, carbon particles, or a mixture thereof;

ii) from 0% to about 45% by weight of aluminum oxide;

iii) from 0% to about 45% by weight of monolithic Ti₄O₇ particle;

iv) from 0% to about 45% by weight of silica or glass fiber;

v) from 0% to about 10% by weight of a conductive metallic particle;

vi) from 0% to about 10% by weight of a conductive metallic wire;

vii) from 0% to about 20% by weight of a conductive metallic flakes; or

viii) from 0% to about 15% by weight of conductive metal carbide particles or fibers.

The conductive material can comprise a baked resin that is an amorphous carbon state or carbon sponge-based composite.

For submerged tube and plate heat exchangers the tubes or plates can comprise:

a) a material chosen from sintered silica carbide, tungsten carbide or boron carbide, titanium sub-oxide ceramic material, or titanium metal; and

b) a dimensionally stable anode coating over at least a portion of the tube, the coating chosen from a ceramic alloy of iridium oxide, a ceramic alloy of ruthenium oxide, a ceramic alloy of titanium oxide, boron doped diamond or nitrogen doped diamond.

### Submerged Tube Heat Exchanger

Disclosed herein are high efficiency heat exchangers. In one aspect the disclosed heat exchangers comprise:

a) a voltage source having a positive terminal and a negative terminal;
b) a heat exchanger assembly comprising:

a housing defining:

i) a process fluid injection chamber;

ii) a heat transfer chamber underlying process fluid injection chamber;

iii) a collection chamber; and

iv) a plurality of hollow elongate tubes extending therebetween and in fluid communication with process fluid injection chamber and collection chamber;

wherein at least a portion of each elongate tube has an outer surface comprising a substantially non-metallic, electrically and thermally conductive material that is in electrical communication with the positive terminal of the voltage source, and wherein at least a portion of the housing has a cathode surface in electrical communication with the negative terminal of the voltage source

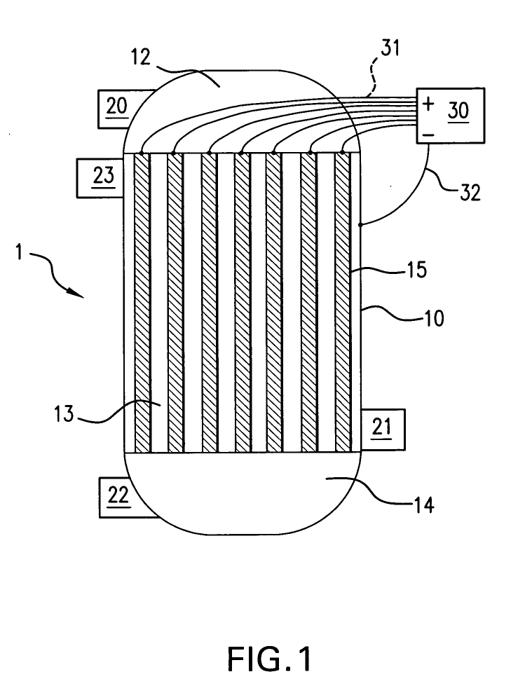

In use, FIG. 1 depicts a non-limiting example of a disclosed heat exchanger. The heat exchanger comprises:

a) voltage source 30 having a positive terminal and a negative terminal;
b) heat exchanger assembly 1 comprising: housing 10 defining:

i) process fluid injection chamber 12;

ii) heat transfer chamber 13 underlying process fluid injection chamber 12;

iii) collection chamber 14; and

iv) a plurality of hollow elongate tubes 15 extending therebetween and in fluid communication with process fluid injection chamber 12 and collection chamber 14.

The elongate tubes 15 depicted in FIG. 1 pass hot process fluid from process

injection chamber 12 to collection chamber 14. Fluid injected into process injection chamber 12 through process fluid inlet 20 is cooled as it passes through elongate tubes 15. The process fluid is cooled by transferring heat through the thermally conductive material that comprises tubes 15 a to raw process fluid contained in heat transfer chamber 13. The cooled process fluid is collected in collection chamber 14. In this use, housing 10 comprises process fluid outlet 22 which allows cooled process fluid to exit collection chamber 14. In addition, housing 10 further comprises raw fluid inlet 23 wherein raw fluid that is at a temperature below the temperature of the process fluid that is injected into chamber 12 enters heat transfer chamber 13 and raw fluid outlet 21 by which warmed raw fluid can exit heat transfer chamber 13. At least a portion of each elongate tube 15 has an outer surface comprising a substantially non-metallic, electrically and thermally conductive material as defined herein that is in electrical communication 31 with the positive terminal of the voltage source. In addition, at least a portion of the housing has a cathode surface as defined herein that is in electrical communication 32 with the negative terminal of the voltage source.

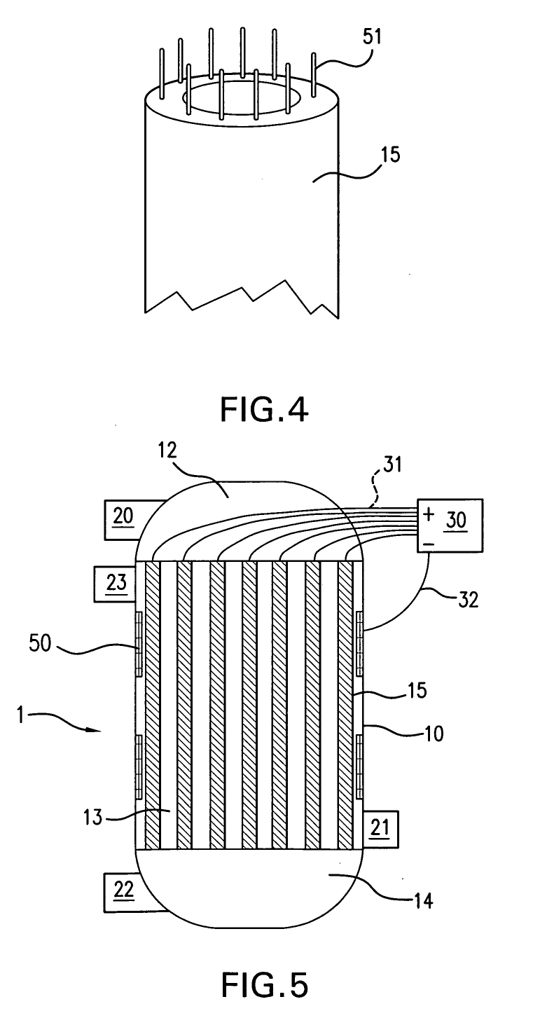

In use, the heat exchanger can comprise, as depicted in FIG. 4, a plurality of elongate tubes 15 having a plurality of internal metal support structures 51. Support structures 51 can be present for reinforcement of tube 15 or, alternatively, structure 51 can comprise a method of electrical communication 31 with the positive terminal of a pulse source, for example, 30 in FIG. 5.

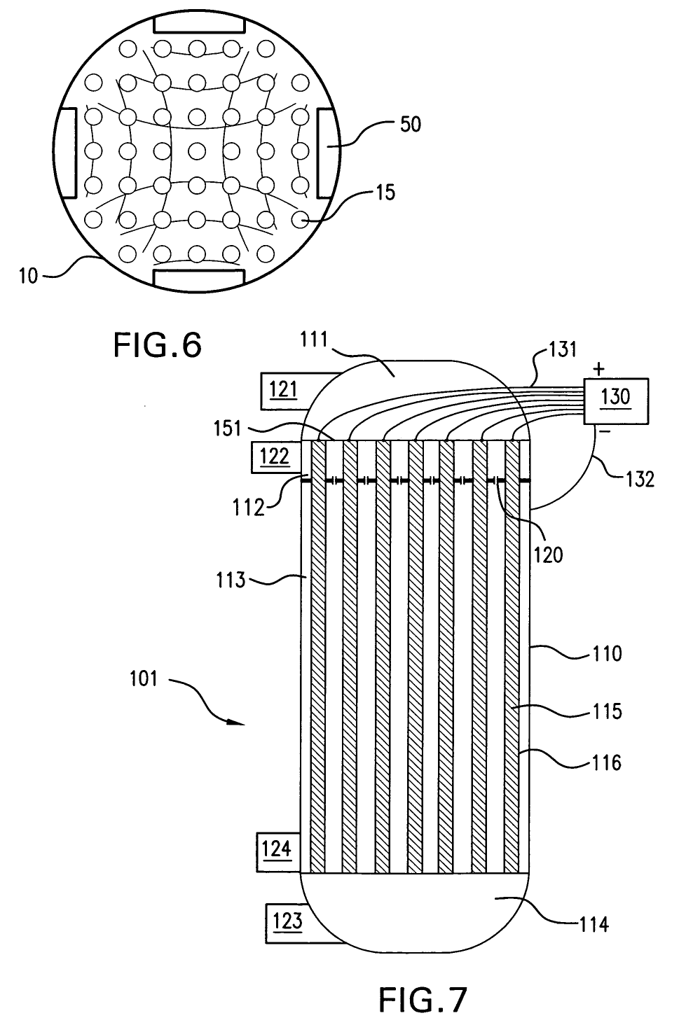

In use, FIG. 5 depicts a heat exchanger comprising one or more sources of ultrasonic energy 50 that are also cathode surfaces. In use, FIG. 6 depicts a top cut away view of one arrangement of tubes 15 and sources of ultrasonic energy 50 in relationship to housing 10. In use, FIG. 6 depicts a heat exchanger wherein the raw fluid flows across the outside of tubes 15 and the process fluid passes through tubes 15. The ultrasonic energy sources 50 act to inhibit the build up of large crystals of inorganic material along the cathode inner surface of the housing and thus cause smaller particles of inert material to not to adhere to the inside surface of the housing. In use, these smaller particles of inert material are carried by flowing raw fluid out of heat transfer chamber 13.

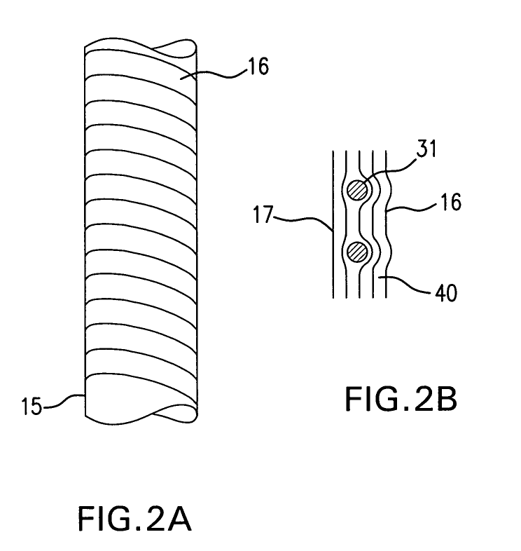

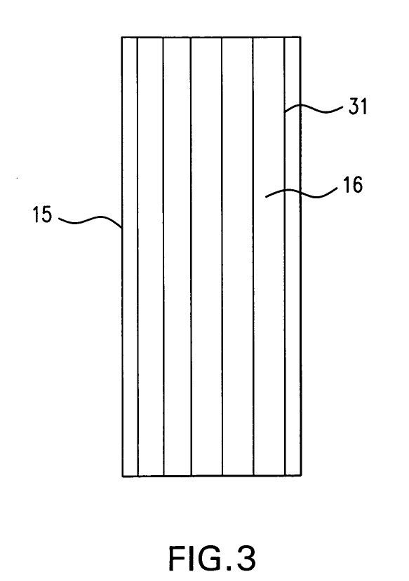

In use, as depicted in FIG. 1-6, pulsed voltage source 30 provides an anionic charge to the surface of tubes 15 and a cationic surface to shell 10. The pulsed voltage source can be any source which provides a direct current, for example, a pulsed direct current source, or an asymmetric alternating current source.

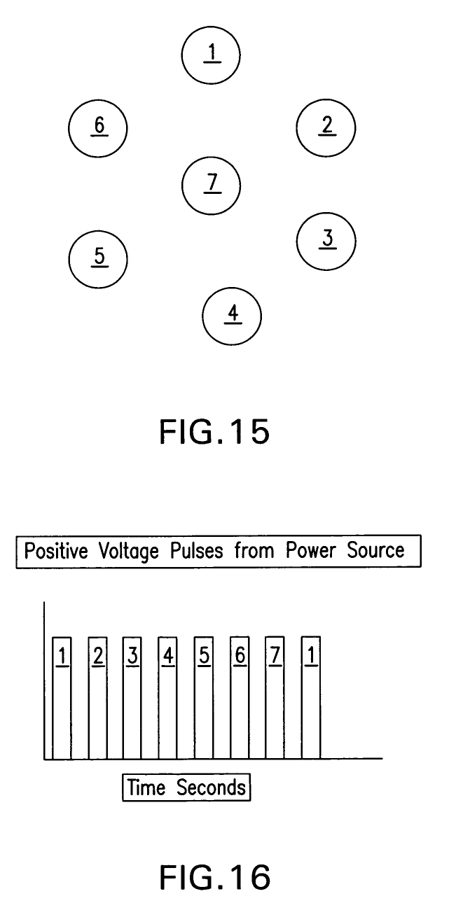

FIG. 15 depicts a partial array of tubes in a submerged tube heat exchanger. In use, the pulsed direct current can be applied in sequence to non-adjacent tubes, for example, when power is applied to tube No. 7 no power is applied to tubes Nos. 1-6. When power is applied to tube No. 2, no power is applied to tubes Nos. 1, 3, and 7 or to other adjacent non-depicted tubes. In this embodiment, at any one time only non-adjacent tubes are receiving a pulse of direct current in the repeated pattern.

In another embodiment of this aspect (concurrent flow), the raw fluid flows into the heat transfer chamber 13 through 21 which is not configured to be an inlet, and out through 23 which is configured to be an outlet. This counter current embodiment has all of the advantages of the concurrent flow embodiment describe above.

In another aspect, the disclosed heat exchangers comprise:

a) a voltage source having a positive terminal and a negative terminal;
b) a heat exchanger assembly comprising:

a housing defining:

i) a process fluid injection chamber;

ii) a raw fluid receiving chamber underlying the process fluid injection chamber;

iii) a heat transfer chamber underlying the raw fluid receiving chamber;

iv) a collection chamber;

v) a raw fluid receiving chamber bottom having a plurality of orifices providing fluid communication between the raw fluid receiving chamber and the heat transfer chamber; and

vi) a plurality of hollow elongate tubes extending therebetween and in fluid communication with the process fluid injection chamber and the collection chamber;

wherein at least a portion of each elongate tube has an outer surface comprising a substantially non-metallic, electrically and thermally conductive material that is in electrical communication with the positive terminal of the voltage source, and wherein at least a portion of the housing has a cathode surface in electrical communication with the negative terminal of the voltage source.

In use, FIG. 7 depicts a non-limiting example of a disclosed heat exchanger according to this aspect. The heat exchanger comprises:

a) voltage source 130 having a positive terminal and a negative terminal;
b) heat exchanger assembly 101 comprising:

housing 110 defining:

i) process fluid injection chamber 111;

ii) raw fluid receiving chamber 112 underlying process fluid injection chamber 111;

iii) heat transfer chamber 113 underlying raw fluid receiving chamber 112;

iv) collection chamber 114;

v) raw fluid receiving chamber bottom 150 having plurality of orifices 120 providing fluid communication between raw fluid receiving chamber 112 and heat transfer chamber 113; and

vi) a plurality of hollow elongate tubes 115 extending therebetween and in fluid communication with process fluid injection chamber 111 and collection chamber 114.

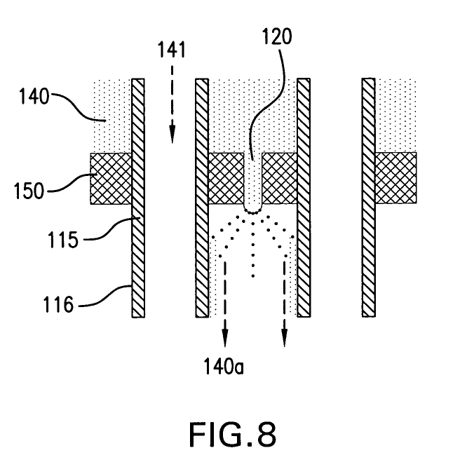

The outer surface of elongate tubes 115 depicted in FIG. 7 receives raw fluid that is injected from raw fluid receiving chamber 112 through orifices 120 to form a falling film that flows along the elongate tube 115 outer surface. The orifice can be a shaped aperture as depicted in FIG. 8, or the aperture can comprise a means for dispersing a raw fluid as a falling film along the tube surface. Examples include a Free Passage Full Cone Nozzle. Nozzles of this type include the MAXIPASS™ (MP) nozzle available from BETE Fog Nozzle, Inc. Greenfield, Mass. 01301 USA. The nozzles can disperse cones having any angle, for example, 30°, 60°, 90°, and 120°. Other suitable nozzles include TFXP™ Full Cone spiral nozzles available from Industrial Mechanical Specialties Inc., Thornhill, Ontario L3T 1N9. In one embodiment, the nozzle is in electrical communication with the positive terminal of a voltage source.

In addition, at least a portion of each elongate tube 115 has an outer surface comprising a substantially non-metallic, electrically and thermally conductive material that is in electrical communication 131 with the positive terminal of the voltage source, and wherein at least a portion of the housing 110 has a cathode surface in electrical communication with 132 the negative terminal of the voltage source.

In use, a raw fluid enters inlet 122 into raw fluid receiving chamber 112 wherein raw fluid flows through orifice 120 and is directed to the surface of elongate tubes 115 in heat transfer chamber 113 as a falling film. At least a portion of the outside surface of tubes 115 is coated with a substantially non-metallic, electrically and thermally conductive material. Process fluid, having a temperature greater than the temperature of the raw fluid entering into heat transfer chamber 113, enters into process fluid injection chamber 111 through inlet 121. The process fluid flows downwardly through the inside of tubes 115 and transfers heat via tubes 115 to the raw fluid circulating in heat transfer chamber 113. The cooled process fluid collects in collection chamber 114 and exits via outlet 123, whereas warmed raw fluid exits heat transfer chamber 113 through outlet 124.

Heat exchangers of this configuration are useful when the raw fluid (cooling fluid) has a high concentration of metal ions, inter alia, sodium, magnesium, calcium, iron, manganese and the like. The falling film depicted in FIG. 7 and FIG. 8 typically has a higher heat transfer rate than submerged heat exchangers and can handle higher amounts of dirt, organic material, and inert particles that might be suspended in the raw fluid.

FIG. 7 depicts heat exchanger 101 comprising shell 110 having process fluid injection chamber 111, raw fluid receiving chamber 112 positioned below process fluid chamber 111, heat transfer chamber 113 positioned below raw fluid receiving chamber 112, and purified process fluid collection chamber 114 positioned below heat transfer chamber 113. A plurality of elongate tubes 115 extends longitudinally from injection chamber 111 to collection chamber 114. Raw fluid receiving chamber top 151 provides separation between injection chamber 111 and receiving chamber 112. As depicted in FIG. 8, receiving chamber bottom 150 has a plurality of ports, openings, or baffles 120 positioned between elongate tubes 115 such that raw fluid 140 entering receiving chamber 112 through inlet 122 is directed from receiving chamber 112 downward in film 140a along tube outside surface 116 into heat transfer chamber 113. Film 140a allows for more efficient transfer of heat between process fluid 141 entering chamber 111 and raw fluid film 140a passing across tube surface 116. The ports, openings, or baffles 120 can utilize one or more types of means for directing the raw fluid onto the elongate tubes.

One aspect of the ports, openings, or baffles 120 for passing raw fluid from raw fluid receiving chamber 112 to heat transfer chamber 113 utilizes cone nozzles, for example, a Free Passage Full Cone Nozzle. Nozzles of this type include the MAXIPASS™ (MP) nozzle available from BETE Fog Nozzle, Inc. Greenfield, Mass. 01301 USA. The nozzles can disperse cones having any angle, for example, 30°, 60°, 90°, and 120°. Other suitable nozzles include TFXP™ Full Cone spiral nozzles available from Industrial Mechanical Specialties Inc., Thornhill, Ontario L3T 1N9. In one embodiment, the nozzle is in electrical communication with the positive terminal of a voltage source.

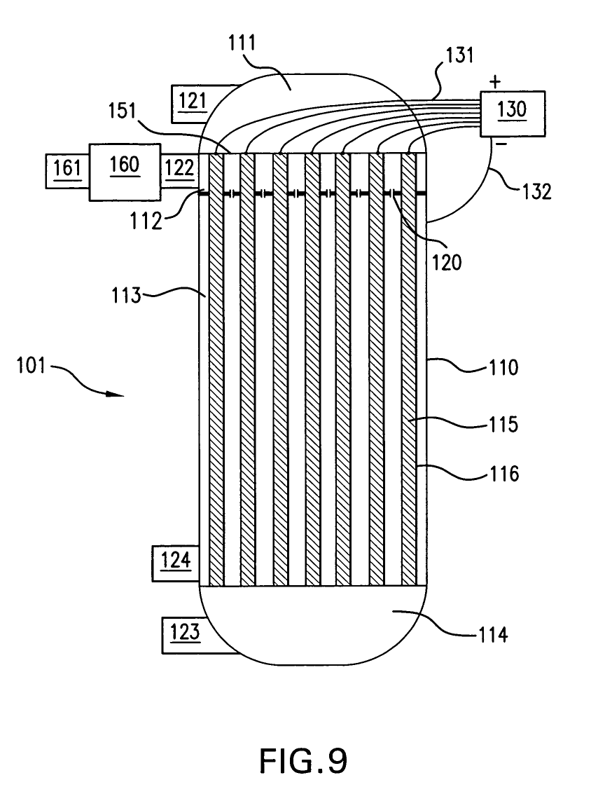

For this aspect of the disclosure, surface 116 comprises an anodically protected, substantially non-metallic, electrically and thermally conductive material as further described herein. In one embodiment of this aspect, the raw fluid entering inlet 122 is pretreated is passed through electro-chemical precipitation cell 160 as depicted in FIG. 9. Raw fluid enters electro-chemical precipitation cell 160 through inlet where seed crystals are formed from incoming raw fluid. This enhancement of precipitation of salts from the raw fluid contributes to the anti-scaling and anti-fouling of tube surface 116.

Orifice 120 can be any type of opening or aperture that can convert raw fluid 140 to raw fluid film 140a. Non-limiting examples of suitable openings or apertures include annular nozzles or whirl/spiral nozzles. In one example, whirl/spiral nozzles are used when large crystals of precipitated salt are present in raw fluid 140.

For this aspect of the disclosure, tube surface 116 comprises a substantially non-metallic, electrically and thermally conductive material as described herein above that is in electrical communication 131 with the positive terminal of a pulsed voltage source 130, and wherein the shell further comprises one or more cathode surfaces in electrical communication 132 with the negative terminal of the pulsed voltage source 130.

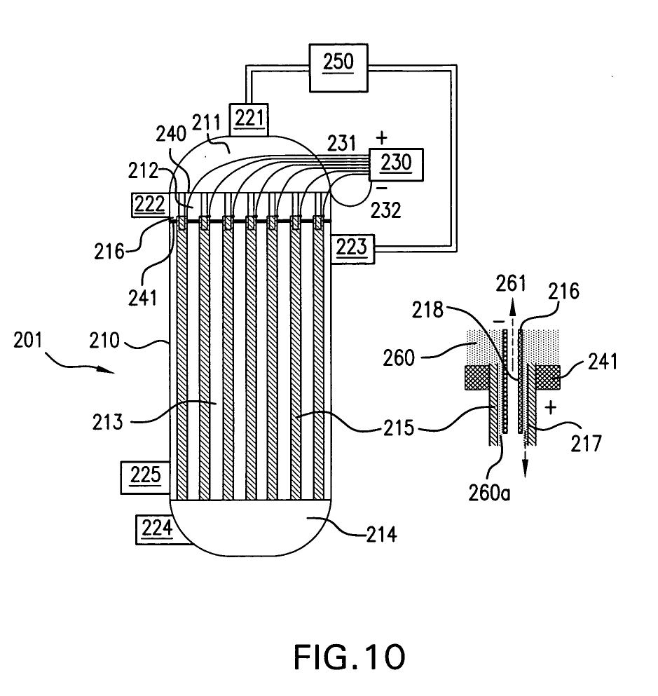

FIG. 9 depicts a further embodiment wherein the heat exchanger further comprises electro-chemical precipitation cell 160 having an ultraviolet light oxidation cell. The ultraviolet light oxidation cell can be used to catalyze the oxidation of organic material with an ore-added additional oxidant. Non-limiting examples of additional oxidants include potassium permanganate, chromium oxide, alkyl peroxides, peroxyacids, hydrogen peroxide precursors, and the like. In the example depicted in FIG. 10, the heat exchanger is adapted for use as part of a vapor compression distillation unit, for example, for use in desalinization of water. However, the disclosed heat exchanger depicted in FIG. 10 can be used to purify liquids at atmospheric pressures.

A further aspect of the disclosed heat exchangers relates to heat exchangers that can distill a liquid from a raw source. For example, pure water can be distilled from sea water which comprises inorganic salts. The raw fluid (sea water), as the water is removed, forms a slurry that can be either recycled until the concentration of solids becomes too high to conveniently recycle, or the slurry can be discharged. Other raw fluid sources can be solid bio masses wherein ethanol is removed by distillation. In addition, sludge can be purified by continuous recycle wherein volatile contaminates are removed or solid contaminates concentrated by the removal of volatiles. In this aspect, the disclosed heat exchangers comprise:

a) a voltage source having a positive terminal and a negative terminal;
b) a vapor compression unit;
c) a heat exchanger assembly comprising:

a housing defining:

i) a vapor collection chamber in fluid communication with the vapor compression unit;

ii) a raw fluid receiving chamber;

iii) a heat transfer chamber underlying the raw fluid receiving chamber) and in fluid communication with the vapor compression unit,

iv) a slurry collection chamber;

v) a plurality of hollow elongate tubes extending therebetween and in fluid communication the raw fluid receiving chamber and the slurry collection chamber; and

vi) a plurality of hollow vapor directing conduits, one vapor directing conduit being positioned at least partially within each respective elongate tube, wherein a proximal end of each vapor directing conduit is in fluid communication with the vapor collection chamber;

wherein at least a portion of each elongate tube has an inner surface comprising a substantially non-metallic, electrically and thermally conductive material that is in electrical communication with the positive terminal of the voltage source, and wherein at least a portion of the vapor directing tubes has a cathode surface in electrical communication with the negative terminal of the voltage source.

In use, FIG. 10 depicts a non-limiting example of a disclosed heat exchanger according to this aspect. The heat exchanger comprises:

a) voltage source 230 having a positive terminal and a negative terminal;
b) vapor compression unit 250;
c) heat exchanger assembly 201 comprising:

a housing 210 defining:

i) vapor collection chamber 211 in fluid communication with vapor compression unit 250;

ii) raw fluid receiving chamber 212;

iii) heat transfer chamber 213 underlying the raw fluid receiving chamber 212 and in fluid communication with vapor compression unit 250;

iv) slurry collection chamber 214;

v) a plurality of hollow elongate tubes 215 extending therebetween and in fluid communication with raw fluid receiving chamber 212 and slurry collection chamber 214; and

vi) a plurality of hollow vapor directing conduits 216, one vapor directing conduit being positioned at least partially within each respective elongate tube, wherein a proximal end of each vapor directing conduit is in fluid communication with the vapor collection chamber; and

wherein at least a portion of each elongate tube 215 has inner surface 217 comprising a substantially non-metallic, electrically and thermally conductive material that is in electrical communication with the positive terminal of the voltage source, and wherein at least a portion of the vapor directing tubes 216 has cathode surface 218 in electrical communication with the negative terminal of the voltage source.

In use, raw fluid receiving chamber 212 has a top 240 that separates receiving chamber 212 from vapor collection chamber 211. Raw fluid receiving chamber 212 further comprises a bottom in fluid communication with the plurality of hollow elongate tubes 215 such that raw fluid 260 can flow from the chamber 212 to form falling film 260a along the inside surface of tubes 215. As depicted in FIG. 10, each elongate tube 215 has a hollow vapor directing conduit 216 at least partially positioned within the tube. As raw fluid falling film 260a falls along the inner surface of tube 215, the fluid is heated by the condensing vapor in heat exchange chamber 213. A portion of the raw fluid falling film is vaporized to process fluid vapor 261 that exits into vapor collection chamber 221 through vapor directing conduit 216 into vapor collection chamber 211. That portion of raw fluid falling film not vaporized is collected in slurry collection chamber 214. As depicted in FIG. 10 the concentrated slurry is discharged via outlet 225. Hollow vapor directing conduit 216 has is in electrical communication with the negative terminal of a voltage source and has cathodic surface 218. The inside surface of tubes 215 are in electrical communication with the positive terminal of a voltage source.

Vapor 261 exits vapor collection chamber 211 through outlet 221 to vapor compression unit 250 configured for receiving process vapor 216 and discharging compressed process vapor into condensing chamber 213 through inlet 223. Process vapor entering condensing chamber 213 circulating along the outside surface of tubes 215 and is condensed into purified fluid that exits outlet 225. The portion of falling film 260a not vaporized is collected in slurry collection chamber 214 and exits by way of outlet 224. When used in desalinization, the slurry exiting outlet 224 has a brine concentration factor that is increased from about 3.2 to about 5.0. In a further embodiment the brine concentration factor is increased from about 2.0 to about 3.2.

Raw fluid entering inlet 222 can be from any source. For example, in systems utilizing the disclosed heat exchanger for desalinization, the raw fluid is typically sea water. For systems providing potable water, the raw fluid can be taken from a river, lake, stream, or holding pond. Another example includes a system for producing ethanol. In this embodiment, either a raw slurry of organic materials or a raw supernatant can enter inlet 222 wherein the composition forms a falling film from which ethanol is extracted.

### Plate Heat Exchangers

A further aspect of the disclosed heat exchangers relates to a plate heat exchanger comprising:

a) a voltage source having a positive terminal and a negative terminal;
b) a heat exchanger assembly comprising:

a housing defining:

a plurality of parallel plates between which are formed alternating chambers;

a first set of alternating chambers for the passage of process fluid or vapor;

a second set of alternating chambers for the passage of raw fluid;

wherein the surface of the plates forming the second set of chambers comprise a substantially non-metallic, electrically and thermally conductive material that is in electrical communication with the positive terminal of a voltage source; and wherein at least a portion of the housing has a cathode surface in electrical communication with the negative terminal of the voltage source.

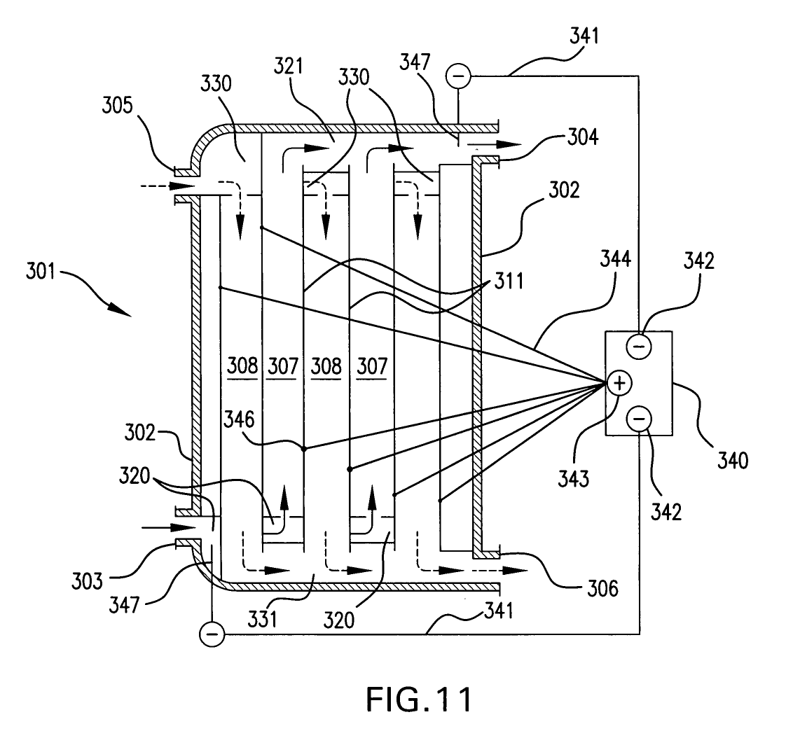

In use, FIG. 11 depicts plate heat exchanger 301 assembly for transferring heat from a process fluid a raw fluid The heat exchanger comprises housing 302, a plurality of parallel plates 311, between which are formed alternating chambers, the first set of alternating chambers 308 for the passage of process fluid or vapor, and the second set of alternating chambers 307 for the passage of raw fluid, a first inlet 305 for directing process fluid or vapor into the first chamber of the first set, a first outlet 306 for discharging cooled process fluid from the last chamber of the first set, a second inlet 303 for directing raw fluid into the first chamber of the second set, a second outlet 304 for discharging heated raw fluid from the last chamber of the second set, a first distribution channel 330 for connecting the first set of chambers, a second distribution channel 320 for connecting the second set of chambers, and wherein the surface of the plates 321 forming the second set of chambers comprise a substantially non-metallic, electrically and thermally conductive material that is in electrical communication 344 with the positive terminal 343 of pulsed voltage source 340, and wherein the shell further comprises one or more cathode surfaces 347 in electrical communication 341 with the negative terminal 342 of pulsed voltage source 340.

The same dimensionally stable, substantially non-metallic, electrically and thermally conductive materials or dimensionally stable, substantially non-metallic, electrically and thermally conductive coatings disclosed herein for submerged tube heat exchangers can also be used for the plate heat exchangers.

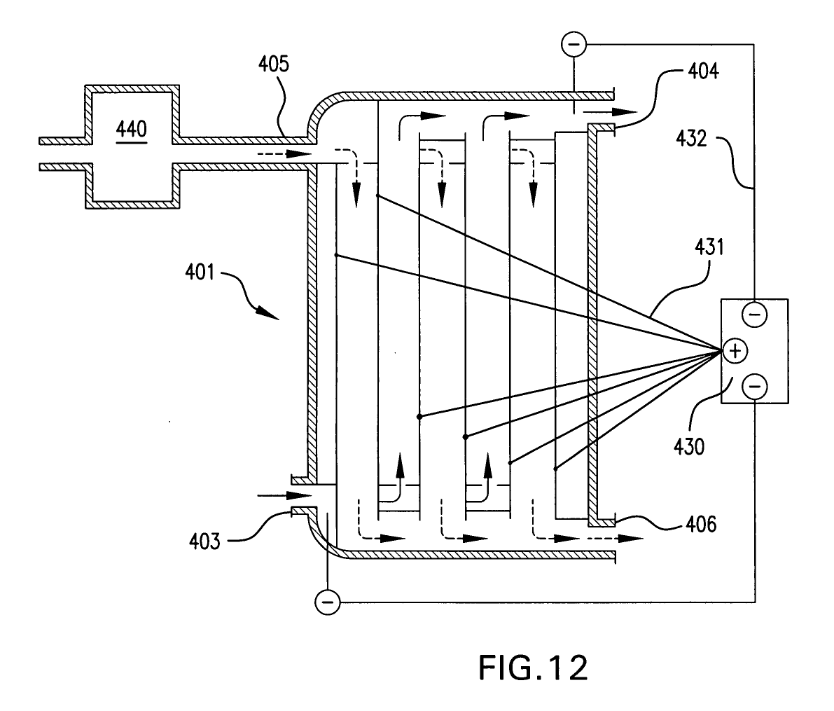

FIG. 12 depicts a plate heat exchanger according to the present disclosure that further comprises an electro-chemical precipitation cell 440.

### High Efficiency Systems

The disclosed heat exchangers can be used as a part of a system for purification of a liquid, for example, by distillation such as water from sea water, or cooling water that has become contaminated. As such, the present disclosure relates to methods for purification of liquids.

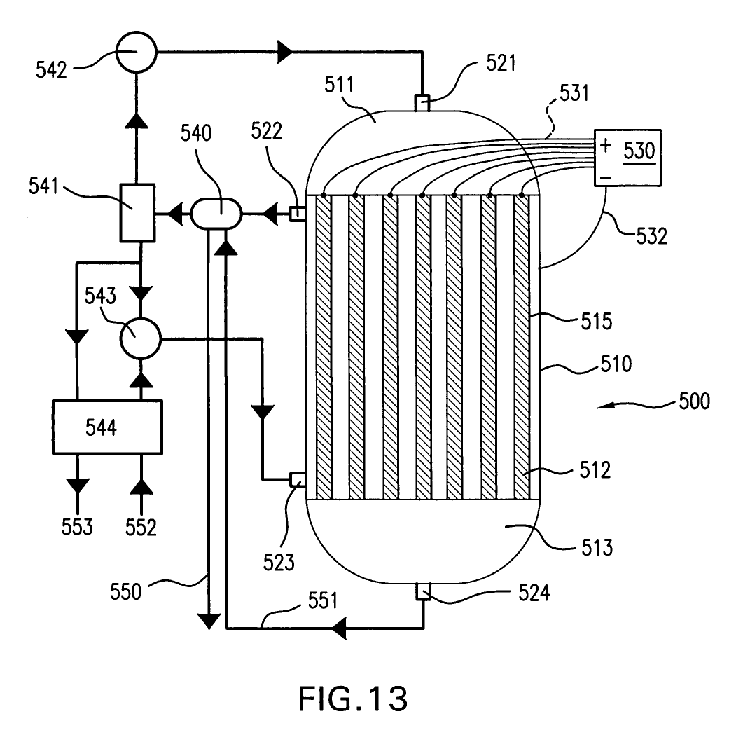

In use, as depicted in FIG. 13, a aspect comprises a method that utilizes one or more of the heat exchangers disclosed herein. For example, purification system 500 comprising:

i) voltage source 530 having a positive terminal and a negative terminal;
ii) heat exchanger assembly comprising:

housing 510 defining:

a) process fluid injection chamber 511;

b) a heat transfer chamber underlying the process fluid injection chamber 511;

c) collection chamber 513; and

d) a plurality of hollow elongate tubes 515 extending therebetween and in fluid communication with process fluid injection chamber 511 and collection chamber 513;

wherein at least a portion of each elongate tube 515 has an outer surface comprising a substantially non-metallic, electrically and thermally conductive material that is in electrical communication 531 with the positive terminal of the voltage source, and wherein at least a portion of the housing has a cathode surface in electrical communication 532 with the negative terminal of the voltage source;
ii) a spray evaporation unit 541;
iii) a vapor compression unit 542; and
iv) a plurality of means for transferring a liquid or a vapor.

As depicted in FIG. 13, an impure liquid serving as a raw fluid source, for example, sea water, waste water, of a fermentation mass, is injected in stream 552 into purification system 500 through plate heat exchanger 544 where the raw fluid is warmed. The raw fluid exits plate heat exchanger 544 and enters pump 543 which is in fluid communication with plate heat exchanger 544, spray evaporation unit 541 and raw fluid inlet 523. Entering pump 543 the heated raw fluid is optionally admixed with recycled raw fluid exiting spray evaporation unit 541 and pumped to the heat transfer chamber via raw fluid inlet 523. The raw fluid circulates upward across the outside surface of hollow tubes 515 wherein their outer surface 516 comprises a substantially non-metallic, electrically and thermally conductive material in electrical communication 531 with the positive terminal of pulsed voltage source 530. The raw fluid is further heated inside the heat transfer chamber and exits outlet 522 which is in fluid communication with thermoelectric cooler 540. Thermoelectric cooler 540 is in fluid communication with spray evaporation unit 541 and purified process fluid outlet 524. Raw fluid enters thermoelectric cooler 540 as is further heated by stream 551 exiting collection chamber 513 by way of purified process fluid outlet 524. Raw fluid enters spray evaporation unit 541 which is vapor communication with vapor compression unit 542. Raw fluid entering spray evaporation unit 541 is partially vaporized wherein the vapor enters vapor compression unit 542 and un-vaporized raw fluid is optionally recycled into pump 543 or discharged through heat exchanger 544 through stream 553 wherein the exiting raw fluid is used to heat raw fluid entering system 500 via stream 552. Condensed vapor exits compression unit 542 that is in vapor communication with inlet 521 and enters injection chamber 511 through inlet 521. The vapor then flows downwardly through tubes 515 wherein the vapor cools and liquefies into process fluid thereby giving off heat and transferring the heat via the tubes to the raw material circulating across the outside of the tubes 515 in the heat exchange chamber. The cooled process fluid collects in collection chamber 513 and exits outlet 524 via stream 551 wherein the process fluid is further cooled in thermoelectric cooler 540 and exist purification system 500 via stream 550. Optionally, a second pump configured for receiving and transferring purified process fluid from heat exchanger 500 to thermoelectric cooler 540 can be placed at any point along feed line 551.

In use, FIG. 13 describes a method for purifying a fluid, for example, obtaining pure water from sea water, ethanol from a biomass, and the like. The process comprises:

a) providing purification system comprising:

i) a voltage source having a positive terminal and a negative terminal;
a heat exchanger assembly comprising:
a housing defining:
a process fluid injection chamber;
a heat transfer chamber underlying the process fluid injection chamber;
a collection chamber; and
a plurality of hollow elongate tubes extending therebetween and in fluid communication with the process fluid injection chamber and the collection chamber;
wherein at least a portion of each elongate tube has an outer surface comprising a substantially non-metallic, electrically and thermally conductive material that is in electrical communication with the positive terminal of the voltage source, and wherein at least a portion of the housing has a cathode surface in electrical communication with the negative terminal of the voltage source;

ii) a spray evaporation unit;

iii) a vapor compression unit; and

iv) a plurality of means for transferring a liquid or a vapor;

b) injecting impure water into the heat exchanger such that the impure water circulates along the outside surface of the heat exchanger tubes wherein the impure water is heated by the transfer of heat from vapor condensing along the inside surface of the heat exchanger tubes;
c) pumping the heated impure water to the spray evaporation unit, wherein a portion of the heated impure water is vaporized to form water vapor;
d) injecting the water vapor into the vapor compression unit wherein the vapor is pressurized to greater than 1 atmosphere of pressure; and
e) injecting the pressurized water vapor into the heat exchanger where the pressurized water vapor condenses on the inner surface of the heat exchanger tubes and forms purified water.

A further embodiment of the system depicted in FIG. 13 relates to desalinization of water. Fresh salt water enters heat exchanger 544 in stream 552 where it is warmed after which the warmed salt water is directed to pump 543 where the warmed salt water is combined with heated salt water exiting spray evaporation unit 541. In another embodiment, heated salt water exiting spray evaporation unit 541 by-passes pump 543 and is directed through heat exchanger 544 and exits the system in stream 553.

Warmed salt water is delivered by pump 543 into heat exchanger 500 through inlet 523 where it circulates along the outside of the plurality of anodically protected, corrosion resistant elongate tubes 515 where the salt water is further warmed by heat transferred from condensing steam inside elongate tubes 515. Salt water, now further heated by the condensing steam, exits through outlet 522 and is directed to thermo-electric cooler 540 where it acts to further cool the desalinated water condensed in the heat exchanger and collected in collecting chamber 513. Desalinated water enters thermo-electric cooler 540 by way of stream 551 and is discharged from the system by way of stream 550. Heated salt water exiting thermo-electric cooler 540 is directed to spray evaporation unit 541 where a portion of the heated salt water is vaporized to steam and this steam is then pulled by partial vacuum into vapor compression unit 542. Vapor compression unit 542 creates a high pressure steam that enters injection chamber 511 through inlet 521. High pressure steam then condenses inside elongate tubes 515 within heat transfer chamber 512 at a temperature higher than 100° C., thereby providing a greater amount of latent heat (higher enthalpy of evaporation) that ca be transferred to the circulating salt water entering inlet 523.

The vapor compression distillation system depicted in FIG. 13 can comprise an anodically protected, corrosion resistant plate heat exchanger, as described further herein, as plate heat exchanger 544. The combination of thermoelectric cooler 540, anodically protected submerged tube heat exchanger 500, and plate heat exchanger 544 provides the artisan with a system that provides energy efficiencies greater than 95%. Depending upon the selection of the dimensionally stable anode coating, heat transfer efficiencies across the elongate tubes can reach efficiencies comparable to highly corrosion susceptible titanium tubing.

The systems disclosed herein can further comprise a vacuum degassing unit for removal of non-condensable gases from the purified process stream. In addition, ultraviolet volatile organic compound (VOC) destruction units can be placed in line at any point to help enhance the anti-scaling capacity of the anodically protected heat exchanger. For embodiments wherein sea water is a source of cooling water, and the system is not configured for desalinization, an electrochemical precipitation cell that provides seed crystal pre-treatment can be inserted at a point prior to entry of the raw process fluid through inlet 523. The artisan by further utilizing a source of ultrasonic energy can provide sufficient agitation within the condensing chamber 512 such that crystals of unwanted inorganic salts readily condense inside the heat exchanger where they can be removed either by flushing or by an outlet not depicted in FIG. 13.

Typically from about 5% to about 10% of the water that comprises the heated salt water entering the spray evaporation unit 541 is converted to vapor that is compressed into compressed pressure steam, however, steady state operations can be readily achieved wherein 8% of the heated salt water is vaporized.

In use, FIG. 13 describes a system useful as a method for desalinization of water, comprising:

a) providing a purification system comprising:

i) a voltage source having a positive terminal and a negative terminal;
a vapor compression unit;
a heat exchanger assembly comprising:
a housing defining:
a vapor collection chamber in fluid communication with the vapor compression unit;
a raw fluid receiving chamber);
a heat transfer chamber underlying the raw fluid receiving chamber and in fluid communication with the vapor compression unit,
a slurry collection chamber;
a plurality of hollow elongate tubes extending therebetween and in fluid communication the raw fluid receiving chamber and the slurry collection chamber; and
a plurality of hollow vapor directing conduits, one vapor directing conduit being positioned at least partially within each respective elongate tube, wherein a proximal end of each vapor directing conduit is in fluid communication with the vapor collection chamber; and
wherein at least a portion of each elongate tube has an inner surface comprising a substantially non-metallic, electrically and thermally conductive material that is in electrical communication with the positive terminal of the voltage source, and wherein at least a portion of the vapor directing tubes has a cathode surface in electrical communication with the negative terminal of the voltage source

ii) a spray evaporation unit; and

iii) a plurality of a means for transferring a liquid or a vapor;

b) injecting salt water into the heat exchanger such that the salt water circulates along the outside surface of the heat exchanger tubes wherein the salt water is heated by the transfer of heat from vapor condensing along the inside surface of the heat exchanger tubes;
c) pumping the heated salt water to the spray evaporation unit, wherein a portion of the heated salt water is vaporized to form water vapor;
d) injecting the water vapor into the vapor compression unit wherein the vapor is pressurized to greater than 1 atmosphere of pressure; and
e) injecting the pressurized water vapor into the heat exchanger where the pressurized water vapor condenses on the inner surface of the heat exchanger tubes and forms purified water.

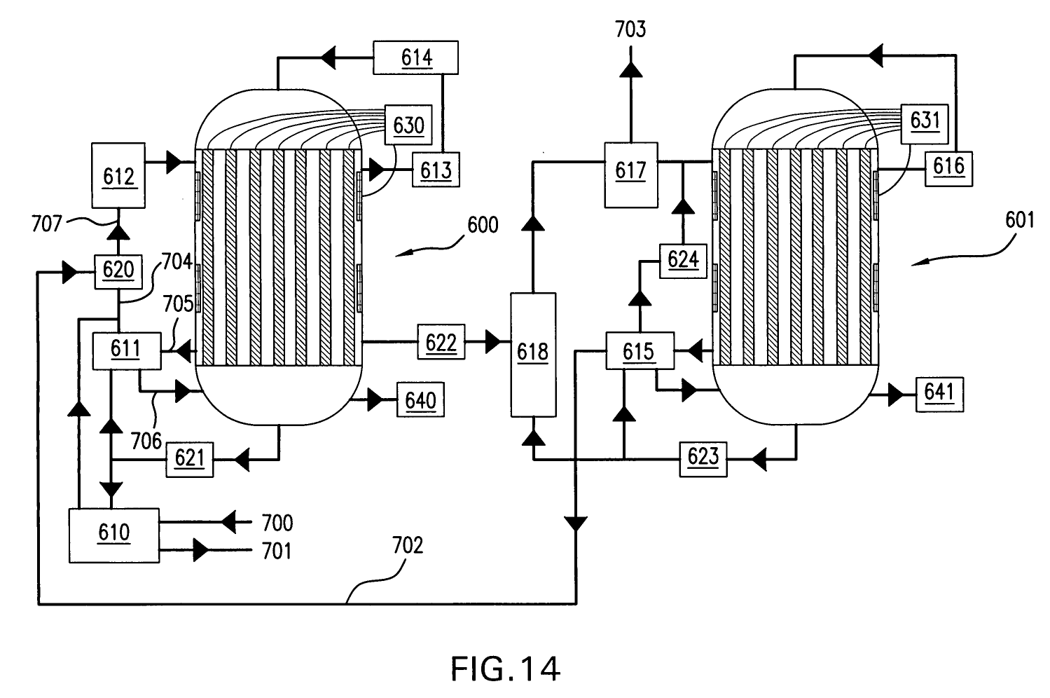

A further embodiment of the disclosed systems includes systems comprising two heat exchangers in series which can be used to for desalinization of water. Two heat exchanger assembly as described herein above and depicted in FIG. 1 through FIG. 6 are in fluid and/or vapor communication as depicted in FIG. 14. A first heat exchanger 600 concentrates the inorganic salts contained in the raw fluid into large crystals forming a slurry. This slurry is then treated with water miscible organic compounds, for example, water soluble organic solvents, to “salt out” the inorganic solids in a second heat exchanger 601. The de-salted water is then recycled back to heat exchanger 600 where it re-enters the continuous cycle. Approximately 5 to 10% of the incoming raw water can be purified in each cycle. In heat exchanger 600, water is vaporized, condensed, and thus purified. In heat exchanger 601 volatile organic compounds that are added in static mixer 618 to “salt-out” the remaining inorganic salts from the distillation step, are vaporized and condensed in exchanger 601 prior to recycle.

In use, FIG. 14 depicts a system for desalinization of water comprising:

A) providing a first heat exchanger comprising:

a) a voltage source having a positive terminal and a negative terminal;

b) a heat exchanger assembly comprising:
a housing defining:
i) a process fluid injection chamber;
ii) a raw fluid receiving chamber underlying the process fluid injection chamber;
iii) a heat transfer chamber underlying the raw fluid receiving chamber wherein the heat transfer chamber further comprises one or more sources of ultrasonic energy;
iv) a collection chamber;
v) a raw fluid receiving chamber bottom having a plurality of orifices providing fluid communication between the raw fluid receiving chamber and the heat transfer chamber; and
vi) a plurality of hollow elongate tubes extending therebetween and in fluid communication with the process fluid injection chamber and the collection chamber;
vii) a vapor compression unit;
viii) an ultraviolet sanitizer;

ix) an ultrasonic electro-chemical precipitation cell;
x) a thermo-electric cooler;
xi) a plate heat exchanger; and
xii) a plurality of fluid pumps;
   wherein at least a portion of each elongate tube has an outer surface comprising a substantially non-metallic, electrically and thermally conductive material that is in electrical communication with the positive terminal of the voltage source, and wherein at least a portion of the housing has a cathode surface in electrical communication with the negative terminal of the voltage source;
   B) a second heat exchanger in fluid communication with the first heat exchanger, the second heat exchanger comprising:

a) a voltage source having a positive terminal and a negative terminal;

b) a heat exchanger assembly comprising:
a housing defining:
i) a process fluid injection chamber;
ii) a raw fluid receiving chamber underlying the process fluid injection chamber;
iii) a heat transfer chamber underlying the raw fluid receiving chamber wherein the heat transfer chamber further comprises one or more sources of ultrasonic energy;
iv) a collection chamber;
v) a raw fluid receiving chamber bottom having a plurality of orifices providing fluid communication between the raw fluid receiving chamber and the heat transfer chamber; and
vi) a plurality of hollow elongate tubes extending therebetween and in fluid communication with the process fluid injection chamber and the collection chamber;
vii) a vapor compression unit;
viii) an ultraviolet sanitizer;
ix) an ultrasonic electro-chemical precipitation cell;
x) a thermo-electric cooler;
xi) a plate heat exchanger;
xii) a static mixer;
xiii) a hydrocyclone; and
xiv) a plurality of pumps;
   wherein at least a portion of each elongate tube has an outer surface comprising a substantially non-metallic, electrically and thermally conductive material that is in electrical communication with the positive terminal of the voltage source, and wherein at least a portion of the housing has a cathode surface in electrical communication with the negative terminal of the voltage source.

In the particular embodiment depicted in FIG. 14, two submerged tube heat exchangers in series configured are configured for use as a desalinization system using water miscible organic compounds to effect the removal of dissolved inorganic materials. In this embodiment, heat exchanger assemblies 600 and 601 are those that are depicted in FIG. 7. Heat exchangers 600 and 601 are configured for receiving feed lines and outlet lines as depicted in FIG. 14. Plate heat exchanger 610 is configured for receiving raw untreated incoming salt water stream 700 and for discharging heated raw salt water towards pump 620 where it is combined with condensed fresh water exiting thermo-electric cooler 611 to form stream 704. Plate heat exchanger 610 is also configured for receiving condensed purified water from pump 621 wherein the purified water is cooled and exits the system as pure water in stream 701. Thermo-electric cooler 611 is configured for receiving salt water from the condensation chamber of heat exchanger 600 via feed line 705 and condensed fresh water from pump 621 wherein the heat from incoming condensed fresh water is transferred to the exiting salt water that makes up part of stream 704. Pump 621 is configured so that a portion of the condensed purified water feeds into heat exchanger 610. Pump 620 is configured for receiving streams 702 and 704. Stream 702 comprises desalted water exiting thermo-electric cooler 615. Stream 704 is an admixture of heated raw salt water and condensed fresh water. The composition of stream 704 can be controlled by the formulator to insure the proper composition of the stream 707 exiting pump 620. Ultrasonic electro-chemical precipitation cell 612 is configured to receive stream 707 and discharge a raw aqueous inorganic salt containing slurry as described herein above for the embodiment depicted in FIG. 7. Once the slurry enters heat exchanger 600 it acts in the manner described herein above for falling film 140a. Compression unit 613 is configured for receiving water vapor from heat exchanger 600 and directing the pressurized vapor to ultraviolet sanitizer 614 after which the pressurized water vapor enters heat exchanger 600 where the vapor is condensed to a liquid inside the heat exchanger tubes.

Pump 622 is configured for receiving a slurry having a high concentration of inorganic salts from heat exchanger 600 and discharging the slurry to static mixer 618. Static mixer 618 is configured for receiving an aqueous slurry from pump 622 and water miscible organic compounds from pump 623. The water miscible organic compound charged to static mixer 618 by way of pump 623 exits the collection chamber of heat exchanger 601. Inside static mixer 618 the bulk of the inorganic salts are precipitated from solution and the resulting slurry of precipitates is pumped to hydrocyclone 617 where the inorganic salts are removed from the system in stream 703. The stream exiting hydrocyclone 617 is directed into heat exchanger 601 which is configured to vaporize the organic compounds from the de-salted water. The organic compounds added to de-salt the aqueous solution entering from heat exchanger 600 via pump 622 is recovered in heat exchanger 601 and discharged via pump 623. Vapor compressor 616 is used to compress the vaporized organic compounds before being fed into the tubes of exchanger 601 where it is condensed into a liquid.

Pulsed voltage sources 630 and 631 provide anode protection to heat exchangers 600 and 601 respectively. Heat exchangers 600 and 601 can further comprise vacuum de-gassing units 640 and 641 respectively to remove non-condensable gases from the system.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

1. A high efficiency heat exchanger, comprising:
a voltage source having a positive terminal and a negative terminal;
a heat exchanger assembly comprising:
a housing defining:
a process fluid injection chamber;
a heat transfer chamber underlying the process fluid injection chamber;
a collection chamber; and
a plurality of hollow elongate tubes extending therebetween and in fluid communication with the process fluid injection chamber and the collection chamber;
wherein at least a portion of each elongate tube has an outer surface comprising a substantially non-metallic, electrically and thermally conductive material that is in electrical communication with the positive terminal of the voltage source, and wherein at least a portion of the housing has a cathode surface in electrical communication with the negative terminal of the voltage source.

2. A high efficiency heat exchanger, comprising:
a voltage source having a positive terminal and a negative terminal;
a heat exchanger assembly comprising:
a housing defining:
a process fluid injection chamber;
a raw fluid receiving chamber underlying the process fluid injection chamber;
a heat transfer chamber underlying the raw fluid receiving chamber;
a collection chamber;
a raw fluid receiving chamber bottom having a plurality of orifices providing fluid communication between the raw fluid receiving chamber and the heat transfer chamber; and
a plurality of hollow elongate tubes extending therebetween and in fluid communication with the process fluid injection chamber and the collection chamber;
wherein at least a portion of each elongate tube has an outer surface comprising a substantially non-metallic, electrically and thermally conductive material that is in electrical communication with the positive terminal of the voltage source, and wherein at least a portion of the housing has a cathode surface in electrical communication with the negative terminal of the voltage source.

3. A high efficiency heat exchanger, comprising:
a voltage source having a positive terminal and a negative terminal;
a vapor compression unit;
a heat exchanger assembly comprising:
a housing defining:
a vapor collection chamber in fluid communication with the vapor compression unit;
a raw fluid receiving chamber;
a heat transfer chamber underlying the raw fluid receiving chamber) and in fluid communication with the vapor compression unit,
a slurry collection chamber;
a plurality of hollow elongate tubes extending therebetween and in fluid communication with the raw fluid receiving chamber and the slurry collection chamber; and
a plurality of hollow vapor directing conduits, one vapor directing conduit being positioned at least partially within each respective elongate tube, wherein a proximal end of each vapor directing conduit is in fluid communication with the vapor collection chamber; and
wherein at least a portion of each elongate tube has an inner surface comprising a substantially non-metallic, electrically and thermally conductive material that is in electrical communication with the positive terminal of the voltage source, and wherein at least a portion of the vapor directing tubes has a cathode surface in electrical communication with the negative terminal of the voltage source.

4. A high efficiency heat exchanger, comprising:
a voltage source having a positive terminal and a negative terminal;
a heat exchanger assembly comprising:
a housing defining:
a plurality of parallel plates between which are formed alternating chambers and;
the first set of alternating chambers for the passage of process fluid or vapor;
the second set of alternating chambers for the passage of raw fluid;
wherein the surface of the plates forming the second set of chambers comprise a substantially non-metallic, electrically and thermally conductive material that is in electrical communication with the positive terminal of a voltage source; and
wherein at least a portion of the housing has a cathode surface in electrical communication with the negative terminal of the voltage source.

5. The heat exchanger according to claim 1, wherein the housing further defines a process fluid inlet that is in fluid communication with the process fluid injection chamber.

6. The heat exchanger according to claim 1, wherein the housing further defines a process fluid outlet that is in fluid communication with the collection chamber.

7. The heat exchanger according to claim 1, wherein the housing further defines a raw fluid inlet that is in fluid communication with the heat transfer chamber.

8. The heat exchanger according to claim 1, wherein the housing further defines a raw fluid outlet that is in fluid communication with the heat transfer chamber.

9. The heat exchanger according to claim 3, wherein the housing further defines a vapor inlet that is in fluid communication with the vapor compression unit and heat transfer chamber.

10. The heat exchanger according to claim 3, wherein the housing further defines a slurry outlet that is in fluid communication with the slurry collection chamber.

11. The heat exchanger according to claim 1, wherein at least a portion of the heat exchanger assembly comprises a corrosion resistant material.

12. The heat exchanger according to any claim 1, wherein at least a portion of the outside surface of tubes comprises a corrosion resistant material.

13. The heat exchanger according to claim 1, wherein the conductive material comprises carbon fiber or a carbon particle mix and a high temperature epoxy resin.

14. The heat exchanger according to claim 1, wherein the conductive material is a baked resin that is an amorphous carbon state or carbon sponge-based composite.

15. The heat exchanger according to claim 1, wherein the conductive material comprises a high temperature epoxy resin and at least one of the following:
i) at least about 27% by weight of carbon fiber, carbon particles, or a mixture thereof;
ii) from 0% to about 45% by weight of aluminum oxide;
iii) from 0% to about 45% by weight of monolithic Ti₄O₇ particle;
iv) from 0% to about 45% by weight of silica or glass fiber;
v) from 0% to about 10% by weight of a conductive metallic particle;
vi) from 0% to about 10% by weight of a conductive metallic wire;
vii) from 0% to about 20% by weight of a conductive metallic flakes; or
viii) from 0% to about 15% by weight of conductive metal carbide particles or fibers.

16. The heat exchanger according to claim 1, wherein the elongate tubes comprise:
a) a material chosen from sintered silica carbide, tungsten carbide or boron carbide, titanium sub-oxide ceramic material, or titanium metal; and
b) a dimensionally stable anode coating over at least a portion of the tube, the coating chosen from a ceramic alloy of iridium oxide, a ceramic alloy of ruthenium oxide, a ceramic alloy of titanium oxide, boron doped diamond or nitrogen doped diamond.

17. The heat exchanger according to claim 1, wherein the surface of the tubes have a surface electrical positive potential of from about 200 mV to about 600 mV and an average surface current density of from about 1 mA/cm² to about 400 mA/cm².

18. The heat exchanger according to claim 1, wherein the tubes comprise a conductive material chosen from:
a) a hydrophobically coated wire coiled along the outside of the tubes;
b) embedded wire coiled along the length of the tubes;
c) a series of hydrophobically coated wires extending longitudinally and in parallel with one another along the surface of the tubes; or
d) a series of metal wires extending longitudinally and in parallel with one another embedded in the wall of the tubes.

19. The heat exchanger according to claim 1, wherein the voltage source is a multi-phase, pulsed direct current source, or an asymmetric alternating current source and each phase is connected to a set of tubes or plates that are not adjacent or contiguous to one another.

20. The heat exchanger according to claim 1, wherein the housing or cathode surface comprises one or more sources of ultrasonic energy.

21. The heat exchanger according to claim 1, further comprising a source of ultraviolet radiation in fluid communication with the is in fluid communication with the process fluid injection chamber.

22. The heat exchanger according to claim 1, wherein vapor formed inside the elongate tubes exits into the vapor collection chamber through the vapor directing tubes.

23. The heat exchanger according to claim 1, wherein the vapor compression unit is configured to receive vapor from the vapor collection chamber and to deliver compressed vapor to the heat transfer chamber.

24. The heat exchanger according to any of claims 1-23, wherein the raw fluid receiving chamber is in fluid communication with a source of fluid.

25. The heat exchanger according to claim 1, wherein the raw fluid receiving chamber is in fluid communication with sea water, brine, or a waste slurry or sludge.

26. The heat exchanger according to claim 2, wherein the orifice is a conical channel that directs raw fluid outwardly onto the surface of the tubes.

27. The heat exchanger according to claim 2, wherein the orifice comprises a cone nozzle for directing raw fluid outwardly onto the surface of the tubes.

28. A method for purifying fluid, comprising:
a) providing a purification system comprising:
i) a voltage source having a positive terminal and a negative terminal;
a heat exchanger assembly comprising:
a housing defining:
a process fluid injection chamber;
a heat transfer chamber underlying the process fluid injection chamber;
a collection chamber; and
a plurality of hollow elongate tubes extending therebetween and in fluid communication with the process fluid injection chamber and the collection chamber;
wherein at least a portion of each elongate tube has an outer surface comprising a substantially non-metallic, electrically and thermally conductive material that is in electrical communication with the positive terminal of the voltage source, and wherein at least a portion of the housing has a cathode surface in electrical communication with the negative terminal of the voltage source;
ii) a spray evaporation unit;
iii) a vapor compression unit; and
iv) a plurality of means for transferring a liquid or a vapor;
b) injecting impure water into the heat exchanger such that the impure water circulates along the outside surface of the heat exchanger tubes wherein the impure water is heated by the transfer of heat from vapor condensing along the inside surface of the heat exchanger tubes;
c) pumping the heated impure water to the spray evaporation unit, wherein a portion of the heated impure water is vaporized to form water vapor;
d) injecting the water vapor into the vapor compression unit wherein the vapor is pressurized to greater than 1 atmosphere of pressure; and
e) injecting the pressurized water vapor into the heat exchanger where the pressurized water vapor condenses on the inner surface of the heat exchanger tubes and forms purified water.

29. A method for the desalination of water, comprising:
a) providing a purification system comprising:
i) a voltage source having a positive terminal and a negative terminal;
a vapor compression unit;
a heat exchanger assembly comprising:
a housing defining:
a vapor collection chamber in fluid communication with the vapor compression unit;
a raw fluid receiving chamber);
a heat transfer chamber underlying the raw fluid receiving chamber and in fluid communication with the vapor compression unit,
a slurry collection chamber;
a plurality of hollow elongate tubes extending therebetween and in fluid communication the raw fluid receiving chamber and the slurry collection chamber; and
a plurality of hollow vapor directing conduits, one vapor directing conduit being positioned at least partially within each respective elongate tube, wherein a proximal end of each vapor directing conduit is in fluid communication with the vapor collection chamber; and
wherein at least a portion of each elongate tube has an inner surface comprising a substantially non-metallic, electrically and thermally conductive material that is in electrical communication with the positive terminal of the voltage source, and wherein at least a portion of the vapor directing tubes has a cathode surface in electrical communication with the negative terminal of the voltage source
ii) a spray evaporation unit; and
iii) a plurality of a means for transferring a liquid or a vapor;
b) injecting salt water into the heat exchanger such that the salt water circulates along the outside surface of the heat exchanger tubes wherein the salt water is heated by the transfer of heat from vapor condensing along the inside surface of the heat exchanger tubes;
c) pumping the heated salt water to the spray evaporation unit, wherein a portion of the heated salt water is vaporized to form water vapor;
d) injecting the water vapor into the vapor compression unit wherein the vapor is pressurized to greater than 1 atmosphere of pressure; and
e) injecting the pressurized water vapor into the heat exchanger where the pressurized water vapor condenses on the inner surface of the heat exchanger tubes and forms purified water.

30. A method for purifying a fluid, comprising:
a) providing:
i) a heat exchanger according to claim 1;
ii) a thermoelectric cooler configured to receive exiting the heat exchanger lower outlet and for further transferring heat from purified process fluid to heated raw process fluid exiting the heat exchanger upper outlet, wherein cooled purified process fluid exits the thermoelectric cooler and is discharged from the system;
iii) a spray evaporation unit configured for receiving further heated raw process fluid exiting the thermoelectric cooler and partially vaporizing further heated raw process fluid into process vapor, and wherein any non-vaporized further heated raw process fluid is discharged either to a plate heat exchanger or to a first pump;
iv) a plate heat exchanger configured for receiving non-vaporized further heated raw process fluid and transferring heat from non-vaporized further heated raw process fluid to fresh raw process fluid entering the system, wherein the non-vaporized raw process fluid is discharged from the system;
v) a first pump configured for receiving and combining non-vaporized further heated raw process fluid and fresh raw process fluid exiting the plate heat exchanger to form raw process fluid, and wherein the pump feeds the raw process fluid to the lower heat exchanger inlet;
vi) a second pump configured for receiving and transferring purified process fluid from the heat exchanger to the thermoelectric cooler; and
vii) a vapor compression unit configured for receiving process vapor from the spray evaporation unit and discharging compressed process vapor to the heat exchanger upper inlet;
b) introducing into the plate heat exchanger a source of unprocessed impure fluid, wherein the impure fluid is heated to a first temperature by exchanging heat with impure fluid exiting the plate heat exchanger;
c) directing the impure fluid heated to a first temperature into the shell of the corrosion resistant, self cleaning heat exchanger, wherein the impure fluid comes into contact with the anodically protected outsider surface of the heat exchanger tubes, and wherein the impure fluid is heated to a second temperature;
d) directing the impure fluid heated to a second temperature into the thermoelectric cooler wherein the impure fluid is heated to a third temperature by exchanging heat with purified fluid exiting the system;
e) directing the impure fluid heated to a third temperature into a spray evaporation chamber wherein the chamber is under reduced pressure, and wherein further a portion of the impure fluid is vaporized;
f) directing the impure fluid that is not vaporized in the spray evaporation chamber to either the plate heat exchanger or combining a portion thereof with impure fluid that has been heated to a first temperature;
g) directing the fluid vapor formed in the spray evaporation chamber into a vapor compression unit wherein the partial pressure of the vapor is raised above 1 atmosphere;
h) directing the compressed vapor to the corrosion resistant heat exchanger wherein the fluid vapor condenses to form purified fluid on the inside surface of the heat exchanger tubes by transferring heat to the impure fluid heated to a first temperature;
i) collecting the condensed purified fluid;
j) directing the condensed purified fluid to the thermoelectric cooler wherein the purified fluid is further cooled by transferring heat to the impure fluid heated to a second temperature; and
k) directing the purified fluid out of the system.
